(19) United States
(12) Patent Application Publication
(10) Pub. No.: US 2023/0410158 A1
(43) Pub. Date: Dec. 21, 2023

(54) Vehicle Comparison Method and Vehicle Comparison Service Providing Server

(71) Applicants: Hyundai Motor Company, Seoul (KR); Kia Corporation, Seoul (KR)

(72) Inventors: Jeewook Huh, Seoul (KR); Dong Ho Yang, Incheon (KR); Hong Suk Kwak, Seoul (KR); Dong-Su Ha, Hwaseong-si (KR)

(21) Appl. No.: 17/974,153

(22) Filed: Oct. 26, 2022

(30) Foreign Application Priority Data
May 27, 2022 (KR) 10-2022-0065279

(51) Int. Cl. G06Q 30/02

(52) U.S. Cl. CPC G06Q 30/0278; G06Q 30/0203

(57) ABSTRACT

An embodiment is a vehicle comparing method including providing a user question and a user propensity test to an application through a user terminal, receiving a response to the user question and the user propensity test from the user terminal, determining a user propensity based on the response, calculating a plurality of vehicle compatibilities representing vehicle-specific characteristics for each of the plurality of vehicles, determining a reference vehicle among the plurality of vehicles by comparing the user propensity with each of the plurality of vehicle compatibilities, and when receiving a response that either vehicle depreciation rate and a vehicle maintenance cost is considered, providing vehicle purchase information in which the reference vehicle is compared with a target vehicle corresponding to a higher trim or model of the reference vehicle according to a result of considering at least one of the depreciation rate of the vehicle and the vehicle maintenance cost.

### CROSS-REFERENCE TO RELATED APPLICATIONS

This application claims the benefit of Korean Patent Application No. 10-2022-0065279, filed on May 27, 2022, which application is hereby incorporated herein by reference.

### TECHNICAL FIELD

The present invention relates to a vehicle comparison method and a vehicle comparison service providing server.

### BACKGROUND

As individuality is emphasized, propensity tests for individuals are being conducted in various forms. When the results of an individual's propensity test are used, it is possible to understand others propensity in advance, so that social consensus may be improved.

In addition, when an individual decides on a career path or a company assigns work to an individual, quantitative indicators, such as grades or test scores, were mainly considered in the past, but in recent years, research is being conducted on methods that take individual propensities into account in various industrial fields because it is possible to predict a suitable career path in advance by using individual propensity, or to strengthen corporate competitiveness by conducting work that suits one's propensity.

The above information disclosed in this background section is only for enhancement of understanding of the background of the invention, and therefore it may contain information that does not form the prior art that is already known to a person of ordinary skill in the art.

### SUMMARY

The present invention has been made in an effort to provide a method and a server for transmitting vehicle comparison information by determining a vehicle to be recommended by matching a vehicle compatibility in consideration of a user propensity and determining a vehicle to be compared with the vehicle to be recommended in providing vehicle information.

An exemplary embodiment of the present invention provides a vehicle comparing method performed by a service providing server, the vehicle comparing method including: providing a user question and a user propensity test to an application through a user terminal, receiving a response to the user question and the user propensity test from the user terminal, determining a user propensity based on the response, calculating a plurality of vehicle compatibilities representing vehicle-specific characteristics for each of the plurality of vehicles, determining a reference vehicle among the plurality of vehicles by comparing the user propensity with each of the plurality of vehicle compatibilities, and when receiving a response that at least one of a vehicle depreciation rate and a vehicle maintenance cost is considered from the user terminal, providing vehicle purchase information in which the reference vehicle is compared with a target vehicle corresponding to a higher trim or a higher model of the reference vehicle according to a result of considering at least one of the depreciation rate of the vehicle and the vehicle maintenance cost.

The determining of the user propensity may include determining the user propensity by a plurality of user propensity factors.

The calculating of the plurality of vehicle compatibilities may include calculating the vehicle compatibility of each vehicle based on a plurality of vehicle compatibility factors for each of the plurality of vehicles, in which the plurality of vehicle compatibility factors may include factors corresponding to the plurality of user propensity factors.

The providing of the vehicle purchase information may include: determining a depreciation rate of the reference vehicle and a depreciation rate of the target vehicle, determining whether a first difference amount based on the depreciation rate of the reference vehicle and the depreciation rate of the target vehicle is less than 0, and when the first difference amount is less than 0, comparing the reference vehicle and the target vehicle and transmitting vehicle comparison information to the user terminal.

The determining of the depreciation rate of the reference vehicle and the depreciation rate of the target vehicle may include: when each of the reference vehicle and the target vehicle is scheduled to be discontinued, determining a depreciation rate of each of the reference vehicle and the target vehicle in consideration of a depreciation rate according to discontinuation, determining a depreciation amount of each of the reference vehicle and the target vehicle according to the depreciation rate of each of the reference vehicle and the target vehicle, and determining a value obtained by adding a vehicle price difference between the reference vehicle and the target vehicle, an interest difference according to the vehicle price difference, and a difference in depreciation amount between the reference vehicle and the target vehicle as the first difference amount.

The determining of the depreciation rate of the reference vehicle and the depreciation rate of the target vehicle may include: when each of the reference vehicle and the target vehicle is not scheduled to be discontinued, calculating a depreciation rate according to a vehicle model expected to be sold at a user's used car selling time based on a period from a release of each of the reference vehicle and the target vehicle to a current time point and the user's used car selling time, reflecting a new model price increase rate of each of the reference vehicle and the target vehicle, determining a depreciation rate of each of the reference vehicle and the target vehicle in consideration of a depreciation rate according to the model of the vehicle and a new model price increase rate of the vehicle, determining a depreciation amount of each of the reference vehicle and the target vehicle according to the depreciation rate of each of the reference vehicle and the target vehicle, and determining a value obtained by adding a vehicle price difference between the reference vehicle and the target vehicle, an interest difference according to the vehicle price difference, and a difference in a depreciation amount between the reference vehicle and the target vehicle as the first difference amount.

The vehicle comparing method may further include: determining a maintenance cost of the reference vehicle and a maintenance cost of the target vehicle when the first difference amount is 0 or more, determining whether a second difference amount based on the maintenance cost of the reference vehicle and the maintenance cost of the target vehicle is less than 0, and when the second difference amount is less than 0, comparing the reference vehicle and the target vehicle and transmitting vehicle comparison information to the user terminal.

The determining of the maintenance cost of the reference vehicle and the maintenance cost of the target vehicle may include calculating the total maintenance cost of each of the reference vehicle and the target vehicle based on an acquisition tax, an annual fuel cost, and an annual auto tax of each of the reference vehicle and the target vehicle.

The vehicle comparing method may further include: when it is determined to reflect a used car selling cost of each of the reference vehicle and the target vehicle in the maintenance cost comparison, calculating a total cost for each of the reference vehicle and the target vehicle by adding the depreciation amount at a used car selling time for each of the reference vehicle and the target vehicle and the total maintenance cost of each of the reference vehicle and the target vehicle, and determining a difference between the total cost for the reference vehicle and the total cost for the target vehicle as a second difference amount.

The vehicle comparing method may further include: when it is determined not to reflect a used car selling cost of each of the reference vehicle and the target vehicle in the maintenance cost comparison, calculating a total cost for each of the reference vehicle and the target vehicle by adding the vehicle price of each of the reference vehicle and the target vehicle and the total maintenance cost of each of the reference vehicle and the target vehicle, and determining a difference between the total cost for the reference vehicle and the total cost for the target vehicle as a second difference amount.

The vehicle comparing method may further include: when the second difference amount is equal to or greater than 0, determining whether a weight of an item representing self-consciousness indicating a user's degree of interest in evaluation of other users on the user among the user propensity factors is equal to or greater than a predetermined level, when the weight of the item representing the self-consciousness is equal to or greater than the predetermined level, determining an installment amount of the reference vehicle and an installment amount of the target vehicle, and comparing the reference vehicle and the target vehicle and transmitting vehicle comparison information to the user terminal.

The vehicle comparing method may further include when the weight of the item representing the self-consciousness is less than the predetermined level, transmitting information about the reference vehicle to the user terminal.

Another exemplary embodiment of the present invention provides a service providing server including a processor coupled to a memory storing program code, the service providing server including: a collecting unit for collecting user information that is a response to a user question and a response to a user propensity test from a user terminal, a user propensity determining unit for determining the user propensity based on the user information and the response to the user propensity test, a vehicle compatibility calculating unit for calculating a plurality of vehicle compatibilities representing vehicle-specific characteristics for each of the plurality of vehicles, a reference vehicle determining unit for determining a reference vehicle among the plurality of vehicles by comparing the user propensity with each of the plurality of vehicle compatibilities, and a higher trim comparing unit for, when receiving a response that at least one of a vehicle depreciation rate and a vehicle maintenance cost is considered from the user terminal, providing vehicle purchase information in which the reference vehicle is compared with a target vehicle corresponding to a higher trim or a higher model of the reference vehicle according to a result of considering at least one of the depreciation rate of the vehicle and the vehicle maintenance cost.

The user propensity determining unit may perform a clustering operation of setting a plurality of user propensity groups based on a weight distribution for each of a plurality of user propensity factors, and based on the response to the user propensity test for each user, determining a user propensity by matching the weight distribution for each user propensity factor and a similar group among a plurality of user propensity groups.

The vehicle compatibility calculating unit may calculate the vehicle compatibility of each vehicle based on a plurality of vehicle compatibility factors for each of the plurality of vehicles, and the plurality of vehicle compatibility factors may include factors corresponding to the plurality of user propensity factors.

The reference vehicle determining unit may determine one of the plurality of vehicles as a reference vehicle by comparing a plurality of user propensity factors indicating the user propensity and a plurality of vehicle compatibility factors indicating a vehicle compatibility for each of the plurality of vehicles.

The higher trim comparing unit may determine a depreciation rate of the reference vehicle and a depreciation rate of the target vehicle when the response that at least one of the vehicle depreciation rate and the vehicle maintenance cost is considered is received from the user terminal, determine a maintenance cost of the reference vehicle and a maintenance cost of the target vehicle when a first difference amount based on the depreciation rate of the reference vehicle and the depreciation rate of the target vehicle is equal to or greater than 0, determine whether a weight of an item representing self-consciousness indicating the degree of interest of a user in an evaluation of other users on the user among the user propensity factors is equal to or greater than a predetermined level when a second difference amount based on the maintenance cost of the reference vehicle and the maintenance cost of the target vehicle is equal to or greater than 0, and determine an installment amount of the reference vehicle and an installment amount of the target vehicle when the weight of the item representing the self-consciousness is equal to or greater than the predetermined level.

The higher trim comparing unit may determine a depreciation rate of each of the reference vehicle and the target vehicle in consideration of the depreciation rate according to discontinuation of each of the reference vehicle and the target vehicle when each of the reference vehicle and the target vehicle is scheduled to be discontinued, and determine a value obtained by adding a vehicle price difference between the reference vehicle and the target vehicle, an interest difference according to the vehicle price difference, and a difference in depreciation rate between the reference vehicle and the target vehicle as the first difference amount.

When each of the reference vehicle and the target vehicle is not scheduled to be discontinued, the higher trim comparing unit may determine a depreciation rate of each of the reference vehicle and the target vehicle in consideration of a depreciation rate according to a vehicle model expected to be sold at a user's used car selling time based on a period from a release of each of the reference vehicle and the target vehicle to a current time point and the user's used car selling time and a new model price increase rate of the vehicle, and determine a value obtained by adding a vehicle price difference between the reference vehicle and the target vehicle, an interest difference according to the vehicle price difference, and a difference in a depreciation rate between the reference vehicle and the target vehicle as the first difference amount.

The higher trim comparing unit may calculate the total maintenance cost of each of the reference vehicle and the target vehicle based on an acquisition tax, an annual fuel cost, and an annual auto tax of each of the reference vehicle and the target vehicle, and calculate a total cost for each of the reference vehicle and the target vehicle by adding the depreciation amount at a used car selling time for each of the reference vehicle and the target vehicle and the total maintenance cost of each of the reference vehicle and the target vehicle when receiving a response that a used car selling cost of the vehicle is reflected from the user terminal, and determine a difference in the total cost between the reference vehicle and the target vehicle as the second difference amount.

The higher trim comparing unit may calculate the total maintenance cost of each of the reference vehicle and the target vehicle based on an acquisition tax, an annual fuel cost, and an annual auto tax of each of the reference vehicle and the target vehicle, and calculate a total cost for each of the reference vehicle and the target vehicle by adding a vehicle price for each of the reference vehicle and the target vehicle and the total maintenance cost of each of the reference vehicle and the target vehicle when receiving a response that a used car selling cost of the vehicle is not reflected from the user terminal, and determine a difference in the total cost between the reference vehicle and the target vehicle as the second difference amount.

When the first difference amount is less than 0, the second difference amount is less than 0, or the weight of the item representing the self-consciousness is equal to or greater than the predetermined level, the higher trim comparing unit may transmit comparison information between the reference vehicle and the target vehicle to the user terminal.

When the weight of the item representing the self-consciousness is less than the predetermined level, the higher trim comparing unit may transmit information about the reference vehicle to the user terminal.

According to the present invention, it is possible to efficiently provide vehicle information to a service provider and to improve the satisfaction of users receiving the service by providing a propensity test to the user, determining a user propensity based on a result of the propensity test, determining a vehicle to be recommended to the user in consideration of the user propensity, and transmitting information about the vehicle to be recommended and a vehicle to be compared in consideration of a vehicle depreciation rate, maintenance cost, user propensity, and the like to the user.

### BRIEF DESCRIPTION OF THE DRAWINGS

FIG. 1 is a block diagram schematically illustrating a vehicle comparison system for providing a vehicle purchase information service in accordance with some embodiments.

FIG. 2 is a flowchart of a vehicle comparison method in accordance with some embodiments.

FIG. 3 is a detailed flowchart of operation S6 of FIG. 2 in accordance with some embodiments.

FIG. 4 is a detailed flowchart of operation S62 of FIG. 3 in accordance with some embodiments.

FIG. 5 is a detailed flowchart of operation S64 of FIG. 3 in accordance with some embodiments.

FIG. 6 is a detailed flowchart of operation S6 of FIG. 2 in accordance with some embodiments.

FIG. 7 is a detailed flowchart of operation S6 of FIG. 2 in accordance with some embodiments.

### DETAILED DESCRIPTION OF ILLUSTRATIVE EMBODIMENTS

Hereinafter, an exemplary embodiment disclosed the present specification will be described in detail with reference to the accompanying drawings, and the same or similar constituent element is denoted by the same reference numeral regardless of a reference numeral, and a repeated description thereof will be omitted. Suffixes, “module” and and/or “unit” for a constituent element used for the description below are given or mixed in consideration of only easiness of the writing of the specification, and the suffix itself does not have a discriminated meaning or role. Further, in describing the exemplary embodiment disclosed in the present disclosure, when it is determined that detailed description relating to well-known functions or configurations may make the subject matter of the exemplary embodiment disclosed in the present disclosure unnecessarily ambiguous, the detailed description will be omitted. Further, the accompanying drawings are provided for helping to easily understand exemplary embodiments disclosed in the present specification, and the technical spirit disclosed in the present specification is not limited by the accompanying drawings, and it will be appreciated that the present invention includes all of the modifications, equivalent matters, and substitutes included in the spirit and the technical scope of the present invention.

Terms including an ordinary number, such as first and second, are used for describing various constituent elements, but the constituent elements are not limited by the terms. The terms are used only to discriminate one constituent element from another constituent element.

In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

A program implemented as a set of instructions embodying a control algorithm required to control another configuration may be installed in a configuration for controlling another configuration under a specific control condition among configurations according to an exemplary embodiment. The control configuration may process input data and stored data according to an installed program to generate output data. The control configuration may include a non-volatile memory to store a program and a memory to store data.

In the specification, a user propensity may include personal propensities that may be considered when a user purchases a vehicle among various personal propensities. Each of these personal propensities may be referred to as a user propensity factor. In the specification, a vehicle compatibility may include a qualitative characteristic of a vehicle corresponding to the user propensity. A user refers to a customer who wants to receive a vehicle recommendation using a vehicle purchase information service according to an exemplary embodiment.

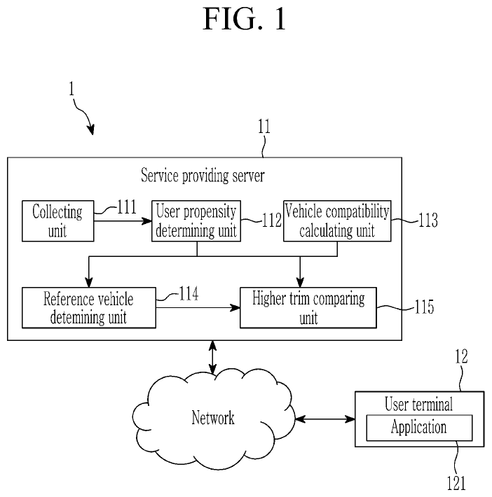

FIG. 1 is a block diagram schematically illustrating a vehicle comparison system for providing a vehicle purchase information service in accordance with some embodiments.

Hereinafter, the vehicle purchase information service may include a service that provides a user terminal with information on a vehicle that a user can purchase through an application.

The vehicle comparison system 1 may include a service providing server 11 and a user terminal 12, and each component is connected to each other through a network. An application 121 is installed in the user terminal 12. As is known, the service providing server 11 may be implemented as a processor capable of executing program codes or instructions stored in an associated memory and may include an interface.

The interface may receive and/or transmit commands/signals from and/or to external devices or users.

The memory may include a non-volatile memory, such as a cache, a Read Only Memory (ROM), a Programmable ROM (PROM), an Erasable Programmable ROM (EPROM), an Electrically Erasable Programmable ROM (EEPROM) and/or a flash memory, and/or a volatile memory, such as a Random Access Memory (RAM).

The processor (or referred to as a control circuit or a controller) may control at least one of other elements (for example: hardware elements (for example: the interface and/or the memory) and/or software elements (software programs) of the service providing server 11, and perform various data processing and calculations. The processor may include a processor and a memory.

The service providing server 11 may provide the user with the vehicle purchase information service according to user information received from the user terminal 12 and a response to a user propensity test. The user information is information necessary for the service providing server 11 to provide the vehicle purchase information service, and may be information necessary to reduce the category of the vehicle. For example, the user information may include information about the user's vehicle purchase budget, the number of people to ride in the vehicle, the user's age, the use of the vehicle, the traveling distance of the vehicle per unit period, the used car selling time, and the like. A question to obtain user information may be called a user question.

The user propensity test may include a question required for the service providing server 11 to determine the user's propensity for vehicle purchase (hereinafter, user propensity). The application 121 may receive the user propensity test from the service providing server 11 through the user terminal 12. When the user responds to the user propensity test, the application 121 may transmit a user's response to the service providing server 11 through the user terminal 12.

A signal received from the service providing server 11 to the user terminal 12 is processed as information by an application processor (AP) of the user terminal 12, and the AP may transmit the corresponding information to the application 121 according to the exemplary embodiment. The application 121 may perform a calculation based on the information received from the AP, and display the result of the performed calculation on the user terminal 12 or transmit the result of the performed calculation to the service providing server 11 through the user terminal 12.

The service providing server 11 may include a collecting unit 111, a user propensity determining unit 112, a vehicle compatibility calculating unit 113, a reference vehicle determining unit 114, and a higher trim comparing unit 115.

The collecting unit 111 collects the user information and user propensity test responses (hereinafter, user propensity responses) received from the user terminal 12. The collecting unit 111 may store the collected user information and user propensity responses in a database.

The user propensity determining unit 112 may determine the user propensity based on the user propensity response collected by the collecting unit 111.

The vehicle compatibility calculating unit 113 may calculate a vehicle compatibility (hereinafter, vehicle compatibility) based on a plurality of vehicle data. The plurality of vehicle data may be data indicating the appearance and performance of the vehicle, such as specifications, price, and color of the vehicle. The plurality of vehicle data may be stored in a database or collected from a server operated by a vehicle manufacturer.

The reference vehicle determining unit 114 may determine a reference vehicle suitable for the user propensity among the plurality of vehicles based on the user information, the user propensity, and the vehicle compatibility for the plurality of vehicles. The reference vehicle may include at least one vehicle to be presented to the user terminal 12 as a purchasable vehicle determined by the service providing server 11 based on the user information and the user propensity.

The higher trim comparing unit 115 may determine a target vehicle corresponding to a higher trim or higher model of the reference vehicle. The higher trim comparing unit 115 may compare the reference vehicle and the target vehicle according to the user propensity, a depreciation rate, maintenance cost, and the like. The depreciation rate may indicate a rate of decrease in the selling price of the vehicle over time, and the maintenance cost may indicate a cost required to maintain the vehicle after the purchase of the vehicle. The target vehicle may be at least one vehicle corresponding to a higher trim than the reference vehicle among a plurality of trims belonging to the same vehicle model as that of the reference vehicle. Accordingly, the option of the target vehicle may be in a higher level than that of the option of the reference vehicle. Alternatively, the target vehicle may be a vehicle belonging to a vehicle type having a higher displacement than that of the reference vehicle while corresponding to the same manufacturer and vehicle type as the manufacturer and vehicle type (for example, sedan, hatchback, SUV, and RV) of the reference vehicle.

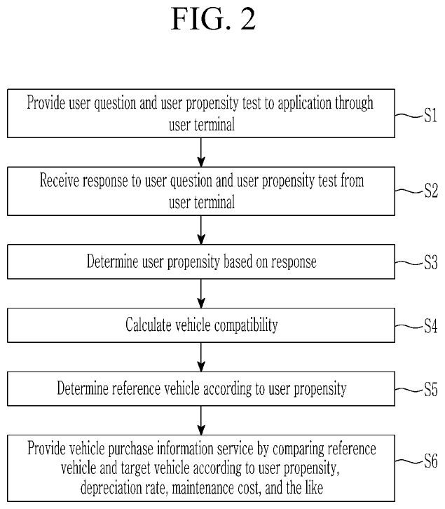

Hereinafter, the operation of each configuration of vehicle comparison system 1 will be described with reference to FIGS. 2 to 7.

FIG. 2 is a flowchart of a vehicle comparison method in accordance with some embodiments.

The collecting unit in may provide a user question and a user propensity test to the application 121 through the user terminal 12 (S1). The application 121 provided with the user question and the user propensity test may receive responses to the user question and the user propensity test from the user through the user terminal 12. For example, a user who wants to purchase a vehicle may input a response to the user question and the user propensity test to the user terminal 12.

The collecting unit 111 may receive the responses to the user question and the user propensity test from the user terminal 12 (S2). The collecting unit 111 may transmit the received response to the user propensity determining unit 112.

The user propensity determining unit 112 may determine a user propensity based on the responses to the user question and the user propensity test (S3). The user propensity determining unit 112 may determine the user propensity by analyzing the responses to the user question and the user propensity test. The user question may include questions about the user's vehicle purchase budget, the number of people to ride in the vehicle, the user's age, the use of the vehicle, a traveling distance of the vehicle per unit period, and the like. The user propensity test may include a question required for the service providing server 11 to determine the user propensity. For example, the user propensity test may include a question of: what are your favorite travel destination between a resorts or a tourist spot?

The user propensity may be determined by a plurality of user propensity factors. The plurality of user propensity factors may include economic feasibility, which indicates the degree of interest of the user in the price of the vehicle, safety, which indicates the degree of interest of the user to the vehicle's defenses against external dangers or accidents, self-consciousness, which indicates the degree of interest of the user in the evaluation on the user of other users, technology, which indicates the degree of interest of the user in new technologies applied to vehicles, reliability, which indicates the degree of interest of the user in the quality evaluation of the vehicle, functionality, which indicates the degree of interest of the user in the performance of the vehicle, and aesthetics, which indicates the degree of interest of the user in the vehicle's design. Here, it may be determined that the higher the self-consciousness, the greater the user's desire to show off through the vehicle. Accordingly, the service providing server 11 may consider that the user with high self-consciousness prefers a vehicle having a high trim or a high displacement, and may provide a service meeting the user propensity. However, the plurality of user propensities are not limited to the contents listed above. That is, various factors that may be considered in determining the user propensity may be further considered in determining the user propensity. The user propensity test may not be a question to directly ask a user propensity, but may be a question for judging a user's value indirectly related to the user propensity.

The user propensity determining unit 112 may determine the user propensity according to a result of performing a clustering operation on the response to the user propensity test. The user propensity determining unit 112 may set a plurality of user propensity groups based on the weight distribution for each user propensity factor, and perform a clustering operation of determining the user propensity by matching the weight distribution for each user propensity factor based on the response to the user propensity test for each user and a similar group among the plurality of user propensity groups.

The plurality of user propensity groups may be determined according to a result obtained by applying clustering to data of a predetermined size or more accumulated with the responses to the user propensity test. The number of the plurality of user propensity groups (N, N is a natural number) may be determined according to the clustering result, and the characteristics of each of the N groups may be defined according to the distribution of weights of the plurality of user propensity factors for each group.

Alternatively, the user propensity determining unit 112 may analyze the response to the user propensity test to define the user propensity with a characteristic of each of a plurality of user propensity factors. The user propensity determining unit 112 may define a characteristic of each user according to the distribution of weights of the plurality of user propensity factors based on the response to the user propensity test for each of the plurality of users.

The user propensity determining unit 112 may transmit data representing the user propensity to the reference vehicle determining unit 114 and the higher trim comparing unit 115.

The vehicle compatibility calculating unit 113 may calculate vehicle compatibilities (hereinafter, a plurality of vehicle compatibilities) indicating characteristics of each vehicle for each of a plurality of vehicles from official data, own data, qualitative data, and the like (S4). The vehicle compatibility may be determined by a plurality of vehicle compatibility factors. The plurality of vehicle compatibility factors may include factors corresponding to the plurality of user propensity factors. Official data may be data based on Consumer Report (CR/USA), AutoBilt (Europe), MotorTrend (USA), IIHS, KNCAP, EuroNCAP, Ministry of Land, Infrastructure and Transport, Ministry of Environment, Ministry of Industry, Insurance Development Institute, JD Power (USA), IF (Europe), IDEA (USA), and vehicle specifications. The own data may be data in which a person who provides a vehicle purchase information service based on the official data associates official data on a vehicle with the plurality of user propensity factors. The qualitative data may be values for the plurality of vehicle compatibility factor items for a vehicle. The vehicle compatibility calculating unit 113 may transmit the data representing the plurality of vehicle compatibilities to the reference vehicle determining unit 114.

The reference vehicle determining unit 114 may determine a reference vehicle according to the user propensity (S5). The reference vehicle determining unit 114 may compare the user propensity with each of the plurality of vehicle compatibilities to determine a vehicle suitable for the user to purchase among the plurality of vehicles as the reference vehicle. The reference vehicle determining unit 114 may determine the reference vehicle by using a standard deviation method and/or a factoring method based on the data representing user propensity.

For example, when the reference vehicle determining unit 114 uses the standard deviation method, it is possible to calculate a difference between the weight of each user propensity factor and the weight of each corresponding vehicle compatibility factor. The reference vehicle determining unit 114 may determine a vehicle having the smallest value as a result of adding up differences between the plurality of user propensity factors and the plurality of vehicle compatibility factors calculated through the standard deviation method as the reference vehicle.

Alternatively, when the reference vehicle determining unit 114 uses the factoring method, it is possible to calculate a product between the weight of each user propensity factor and the weight of each corresponding vehicle compatibility factor. The reference vehicle determining unit 114 may determine a vehicle having the largest value as a result of summing products calculated through the factoring method for the plurality of user propensity factors and the plurality of vehicle compatibility factors as the reference vehicle. When the factoring method is used, the vehicle's advantage and the higher compatibility among and the user propensities may be matched. The reference vehicle determining unit 114 may transmit data representing the reference vehicle to the higher trim comparing unit 115.

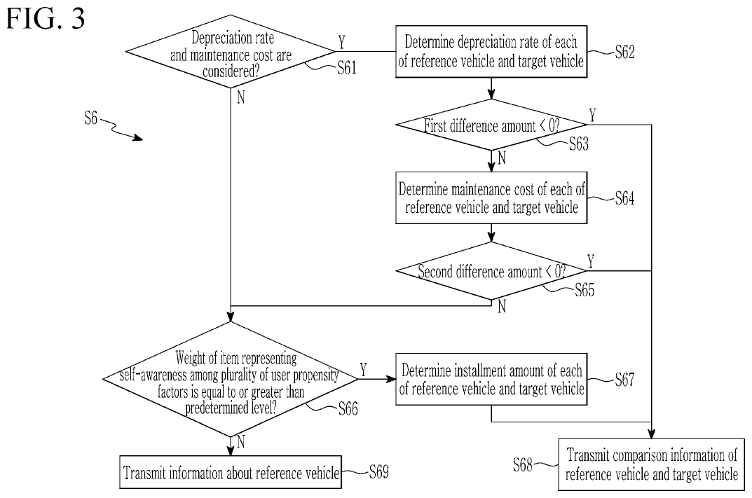

The higher trim comparing unit 115 may provide a vehicle purchase information service by comparing the reference vehicle and the target vehicle according to the user propensity, the depreciation rate, the maintenance cost, and the like (S6). Hereinafter, a detailed order of operation S6 will be described with reference to FIG. 3.

FIG. 3 is a detailed flowchart of operation S6 of FIG. 2 in accordance with some embodiments.

The higher trim comparing 115 may determine whether to consider a depreciation rate and a maintenance cost for vehicle comparison (S61). The higher trim comparing unit 115 may inquire of the user terminal 12 whether to consider the depreciation rate and maintenance cost for vehicle comparison. The user may select an item to be considered for vehicle comparison between the depreciation rate and the maintenance cost for vehicle comparison and input the selected item to the user terminal 12. For example, the higher trim comparing unit 115 may transmit a question inquiring whether to consider the depreciation rate and the maintenance cost to the user terminal 12. When the user terminal 12 receives the question, the application 121 may provide the user through the user terminal 12 with a screen inquiring whether to consider the depreciation rate and the maintenance cost for vehicle comparison. When the user inputs a response to the question through the user terminal 12, the application 121 may transmit the response regarding whether to consider the depreciation rate and the maintenance cost to the service providing server 11 through the user terminal 12. When the response received from the user terminal 12 is the response that the depreciation rate and the maintenance cost are considered for the vehicle comparison, the higher trim comparing unit 115 may consider the depreciation rate and the maintenance cost for the vehicle comparison.

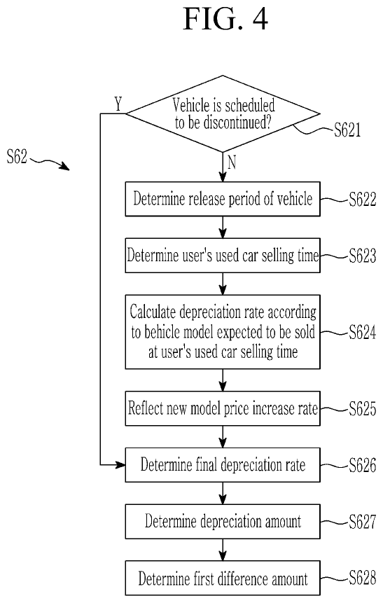

When the depreciation rate and the maintenance cost are considered in operation S61, the higher trim comparing unit 115 may determine the depreciation rate of each of the reference vehicle and the target vehicle (S62). When the depreciation rate of the target vehicle is less than the depreciation rate of the reference vehicle, the service providing server 11 may transmit data indicating the depreciation rate of each of the reference vehicle and the target vehicle to the user terminal 12. When the user terminal 12 receives the data indicating the depreciation rate, the application 121 may provide a screen indicating the depreciation rate of each of the reference vehicle and the target vehicle to the user through the user terminal 12. The higher trim comparing unit 115 may determine the depreciation rate of each of the reference vehicle and the target vehicle in consideration of a new model release cycle, a partial change model release cycle, model discontinuation, a price increase rate of a new model, and the like. Hereinafter, a detailed order of operation S62 will be described with reference to FIG. 4.

FIG. 4 is a detailed flowchart of operation S62 of FIG. 3 in accordance with some embodiments.

The higher trim comparing unit 115 may sequentially apply operations S621 to S627 to each of the reference vehicle and the target vehicle. Therefore, in the description of operations S621 to S627 below, each of the reference vehicle and the target vehicle may be referred to as a vehicle.

The higher trim comparing unit 115 may consider whether the vehicle is scheduled to be discontinued (S621).

When the vehicle is not scheduled to be discontinued, the higher trim comparing unit 115 may determine a period from the release of the vehicle to the current time point (hereinafter, referred to as the vehicle release period) (S622). For example, the vehicle release period may be in units of months.

The higher trim comparing unit 115 may determine a user's used car selling time for the vehicle (S623). The user's used car selling time may be included in the user information collected by the collecting unit 111. Alternatively, the higher trim comparing unit 115 may predict the user's used car selling time for the vehicle based on the response to the test. When the user information does not include the user's used car selling time, the higher trim comparing unit 115 may determine a vehicle replacement cycle according to the user propensity by using big data, and estimate and determine the user's used car selling time according to the determined vehicle replacement cycle. For example, the higher trim comparing unit 115 may determine the time after three or five years from the current time as the user's used car selling time.

The higher trim comparing unit 115 may calculate a depreciation rate z according to the model of the vehicle expected to be sold at the user's used car selling time (S624). For example, in the case where the user's used car selling time is 5 years after the current time, when the vehicle to be sold 5 years after the current time is not the currently sold model, but a partially changed model from the currently sold model, the higher trim comparing unit 115 may reflect the depreciation rate according to the release of the partially changed model in the final depreciation rate calculation.

It may be assumed that the new model release cycle of the vehicle is β, when the new model is released, the price gap between the new model and the current model is γ, the vehicle's partial change model release cycle is δ, when the partially changed model is released, the price gap between the partially changed model and the current model is c, the vehicle release period is x, and the user's used car selling time is y.

A current model A, a partially changed model B, and a new model C at the user's used car selling time may be divided from the new model release cycle β and the partially changed model release cycle δ of the vehicle. When a new model is released after the partially changed model is released according to the reference time point and release cycle, the depreciation rate may be reflected using the method of reflecting both B and C.

That is, higher trim comparing unit 115 may compare the period (x+y) from the release of the vehicle to the user's used car selling time with each of the new model release cycle β of the vehicle, and the partially changed model release cycle δ of the vehicle, and determine the depreciation rate z according to the model of the vehicle expected to be sold at the selling time. The depreciation rate determined according to the model of the vehicle expected to be sold at the selling time is hereinafter referred to as the vehicle model change depreciation rate.

When x+y<δ, the model of the vehicle expected to be sold at the selling time is the current model A, when δ x+y<β, the model of the vehicle expected to be sold at the selling time is the partially changed model B, when β≤x+y<β+δ, the model of the vehicle expected to be sold at the selling time is the new model C, and when β+δ≤x+y, the model of the vehicle expected to be sold at the selling time is a partially changed model of the new model (C+B).

For example, when the model of the vehicle expected to be sold at the selling time is the current model (A), the higher trim comparing unit 115 may determine that the vehicle model change depreciation rate z is 0, when the model at the selling time is B, the higher trim comparing unit 115 may determine that the vehicle model change depreciation rate z is ε, when the model at the selling time is C, the higher trim comparing unit 115 may determine that the vehicle model change depreciation rate z is β, and when the model at the selling time is C+B, the higher trim comparing unit 115 may determine that the vehicle model depreciation rate z is ε+β.

The higher trim comparing unit 115 may reflect the new model price increase rate of the vehicle (S625). The new model price increase rate may be a rate at which the price of the new model increases based on the price of the current model of the vehicle. When the new model price increase rate of the vehicle is high, this also affects the used car selling price of the existing vehicle. Accordingly, the higher trim comparing unit 115 may equally apply the new model price increase rate of the vehicle to the used car market price of the vehicle.

When the vehicle is scheduled to be discontinued in operation S621 or subsequent to operation S625, the higher trim comparing unit 115 may determine the final depreciation rate in consideration of a depreciation rate ζ due to discontinuation, or a vehicle model change depreciation rate z and the new model price increase rate η of the vehicle (S626). When the vehicle is scheduled to be discontinued in operation S621, the higher trim comparing unit 115 may determine the final depreciation rate in consideration of the depreciation rate ζ due to discontinuation. In addition, subsequent to operation S625, the higher trim comparing unit 115 may determine the final depreciation rate in consideration of the vehicle model change depreciation rate z and the new model price increase rate η of the vehicle.

The higher trim comparing unit 115 may determine the depreciation amount of the vehicle by multiplying the vehicle price and the final depreciation rate (S627).

The higher trim comparing unit 115 may determine a first difference amount based on the vehicle price difference, the interest difference, and the depreciation amount difference (S628).

The vehicle price difference is a value obtained by subtracting the current price of the reference vehicle from the current price of the target vehicle. The interest difference is a value representing the total interest incurring according to the installment interest rate with respect to the vehicle price difference. The depreciation amount difference is a value obtained by subtracting the depreciation amount of the reference vehicle from the depreciation amount of the target vehicle. For example, the first difference amount=the difference in vehicle price+the difference in interest+the difference in depreciation amount. When the first difference amount is less than 0, the service providing server 11 may recommend the purchase of the target vehicle.

Referring to FIG. 3, the higher trim comparing unit 115 may determine whether the first difference amount is less than 0 (S63).

When the first difference amount is equal to or greater than 0 in operation S63, the higher trim comparing unit 115 may determine the maintenance cost of each of the reference vehicle and the target vehicle (S64). When the maintenance cost of the target vehicle is lower than the maintenance cost of the reference vehicle, the service providing server 11 may transmit data indicating the maintenance cost of each of the reference vehicle and the target vehicle to the user terminal 12. When the user terminal 12 receives the data indicating the maintenance cost, the application 121 may provide a screen displaying the maintenance cost of each of the reference vehicle and the target vehicle to the user through the user terminal 12. The higher trim comparing unit 115 may determine the maintenance cost of each of the reference vehicle and the target vehicle in consideration of acquisition tax, fuel cost, auto tax, and the like.

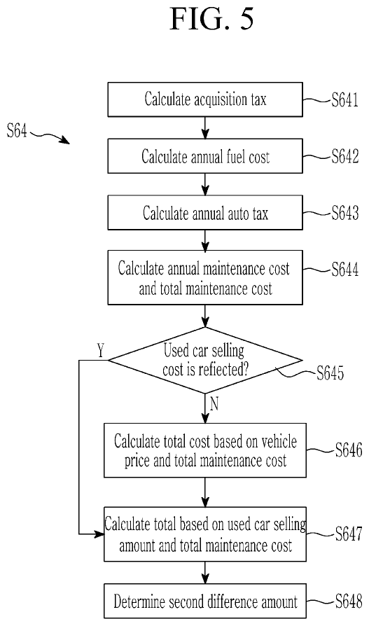

Hereinafter, a detailed order of operation S64 will be described with reference to FIG. 5.

FIG. 5 is a detailed flowchart of operation S64 of FIG. 3 in accordance with some embodiments.

The higher trim comparing unit 115 may sequentially apply operations S641 to S647 to each of the reference vehicle and the target vehicle. Therefore, in the description of operations S641 to S647 below, each of the reference vehicle and the target vehicle may be referred to as a vehicle.

The higher trim comparing unit 115 may calculate a vehicle acquisition tax (S641). For example, the higher trim comparing unit 115 may calculate 7% of the vehicle price excluding the VAT as the vehicle acquisition tax.

The higher trim comparing unit 115 may calculate an annual fuel cost of the vehicle (S642). The higher trim comparing unit 115 may obtain fuel efficiency information of the vehicle based on a plurality of vehicle data. The higher trim comparing unit 115 may obtain oil price information provided by Korea National Petroleum Corporation. The higher trim comparing unit 115 may calculate the fuel cost based on the annual travelling distance, the fuel efficiency of the vehicle, and the oil price. For example, the annual fuel cost=annual travelling distance/fuel efficiency×oil price.

The higher trim comparing unit 115 may inquire about the annual travelling distance of the vehicle to the user terminal 12. The user may select the annual travelling distance of the vehicle and input the selected annual travelling distance into the user terminal 12. When the user terminal 12 receives the question, the application 121 may provide a screen inquiring about the annual travelling distance of the vehicle to the user through the user terminal 12. When the user inputs a response to the question through the user terminal 12, the application 121 may transmit the response to the question for the annual travelling distance for the user's vehicle to the service providing server 11 through the user terminal 12. When the response to the question for the user's annual travelling distance for the vehicle is received from the user terminal 12, the higher trim comparing unit 115 may calculate an annual fuel cost based on the annual traveling distance that is the user's response. Alternatively, when the user does not respond to the question for the annual travelling distance, the higher trim comparing unit 115 may calculate the annual fuel cost based on a predetermined annual travelling distance.

The higher trim comparing unit 115 may calculate the annual auto tax of the vehicle (S643). The higher trim comparing unit 115 may acquire the displacement of the vehicle based on the plurality of vehicle data. The higher trim comparing unit 115 may calculate an annual auto tax of the vehicle based on the displacement of the vehicle.

The higher trim comparing unit 115 may calculate an annual maintenance cost and a total maintenance cost of the vehicle (S644). The annual maintenance cost may be a value obtained by adding an annual auto tax to the annual fuel cost. The higher trim comparing unit 115 may calculate the total maintenance cost based on the vehicle acquisition tax, the user's used car selling time y, the annual maintenance cost, and the like. For example, total maintenance cost=acquisition tax+(user's used car selling time x annual maintenance cost).

The higher trim comparing unit 115 may determine whether to reflect the used car selling cost of the vehicle in the maintenance cost comparison according to the user's selection (S645). The higher trim comparing unit 115 may inquire of the user terminal 12 whether to reflect the used car selling cost in the maintenance cost comparison. The user may select an item to be reflected in the maintenance cost comparison and input the selected item into the user terminal 12. For example, the higher trim comparing unit 115 may transmit a question inquiring whether to reflect the used car selling cost to the user terminal 12. When the user terminal 12 receives the question, the application 121 may provide a screen to the user through the user terminal 12 to inquire whether to reflect the used car selling cost in the maintenance cost comparison. When the user inputs the response to the question through the user terminal 12, the application 121 may transmit the response to whether to reflect the used car selling cost the service providing server 11 through the user terminal 12. When the response received from the user terminal 12 is a response that the used car selling cost is reflected in the maintenance cost comparison, the higher trim comparing unit 115 may reflect the used car selling cost in the maintenance cost comparison.

When the used car selling cost is not reflected, the higher trim comparing unit 115 may calculate the total cost based on the vehicle price and the total maintenance cost (S646). For example, entire cost=vehicle price+total maintenance cost.

When the used car selling cost is reflected, the higher trim comparing unit 115 may calculate the total cost based on the depreciation amount and the total maintenance cost at the user's used car selling time (S646). For example, the total cost=the depreciation amount at the user's used car selling time+the total maintenance cost.

The higher trim comparing unit 115 may determine a second difference amount based on the total cost (S648). The second difference amount is a value obtained by subtracting the total cost of the reference vehicle from the total cost of the target vehicle. When the second difference amount is less than 0, the service providing server 11 may recommend purchase of the target vehicle.

Referring to FIG. 3, the higher trim comparing unit 115 may determine whether the second difference amount is less than 0 (S65).

When the second difference amount is equal to or greater than 0 in operation S65, the higher trim comparing unit 115 may determine whether the weight of the item representing self-consciousness among the plurality of user propensity factors is equal to or greater than a predetermined level (S66). For example, when the weight of the item representing self-consciousness among the plurality of user propensity factors is 8 or more out of 10, the higher trim comparing unit 115 may determine that the weight of self-consciousness among the plurality of user propensities is the predetermined level or more.

When the weight of self-consciousness is equal to or greater than the predetermined level in operation S66, the higher trim comparing unit 115 may determine an installment amount of each of the reference vehicle and the target vehicle (S67). The higher trim comparing unit 115 may determine an installment amount according to a predetermined installment period for each of the vehicle price of the reference vehicle and the vehicle price of the target vehicle. The predetermined installment period may be a period selected by the user, or may be a period predetermined by initial information.

When the first difference amount is less than 0 in operation S63, when the second difference amount is less than 0 in operation S65, or subsequent to operation S67, the higher trim comparing unit 115 may transmit comparison information between the reference vehicle and the target vehicle to the user terminal 12 (S68). The comparison information between the reference vehicle and the target vehicle may include the first difference amount between the reference vehicle and the target vehicle, the second difference amount between the reference vehicle and the target vehicle, or the installment amount of each of the reference vehicle and the target vehicle. When the user terminal 12 receives data indicating the comparison information between the reference vehicle and the target vehicle, the application 121 may provide a screen indicating the comparison information between the reference vehicle and the target vehicle to the user through the user terminal 12.

For example, when the first difference amount is less than 0 in operation S63, the higher trim comparing unit 115 may transmit the comparison information including the first difference amount based on the depreciation rate of each of the reference vehicle and the target vehicle to the user terminal 12. In addition, when the second difference amount is less than 0 in operation S65, the higher trim comparing unit 115 may transmit the comparison information including the second difference amount based on the maintenance cost of each of the reference vehicle and the target vehicle to the user terminal 12. In addition, subsequent to operation S67, the higher trim comparing unit 115 may transmit the comparison information including the installment amount of each of the reference vehicle and the target vehicle to the user terminal 12.

When the weight of self-consciousness is less than the predetermined level in operation S66, the higher trim comparing unit 115 may transmit information on the reference vehicle to the user terminal 12 (S69). The information about the reference vehicle may include the installment amount of the reference vehicle. When the user terminal 12 receives the data indicating the information about the reference vehicle, the application 121 may provide a screen indicating the information about the reference vehicle to the user through the user terminal 12.

As such, the higher trim comparing unit 115 may compare the reference vehicle and the target vehicle in consideration of the user propensities, the depreciation rates, the maintenance costs, and the like, determine whether to provide the information about the reference vehicle or whether to provide the comparison information between the reference vehicle and the target vehicle, and transmit the information to the user terminal 12 according to a result of the determination.

In operation S61 of FIG. 3, it is described that when the user inputs that the depreciation rate and the maintenance cost are to be considered for the vehicle comparison, the higher trim comparing unit 115 proceeds in the order of operations S62 to S65, but the invention is not limited thereto.

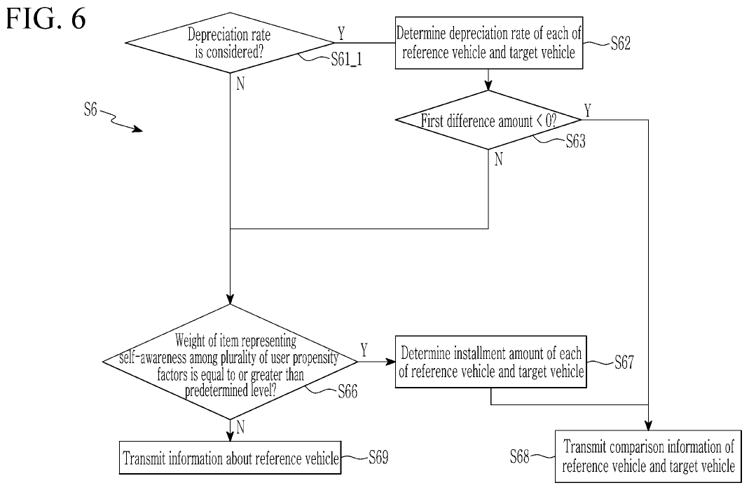

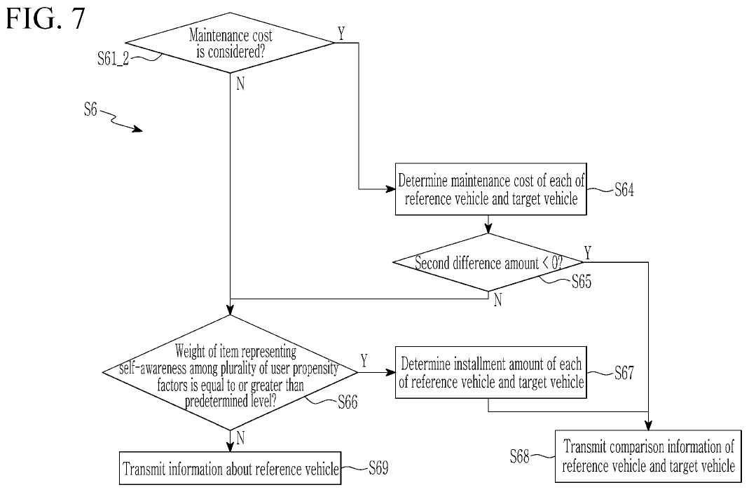

Hereinafter, an example of a case in which the user inputs that any one of the depreciation rate and the maintenance cost is to be considered for vehicle comparison will be described with reference to FIGS. 6 and 7. When the response received from the user terminal 12 is the response that any one of the depreciation rate and the maintenance cost is to be considered for vehicle comparison, the higher trim comparing unit 115 may consider the selected one of between the depreciation rate and the maintenance cost for vehicle comparison. Hereinafter, in the description of the higher trim comparing unit 115, a description of a part overlapping with the previous description may be omitted.

FIG. 6 is a detailed flowchart of operation S6 of FIG. 2 in accordance with some embodiments.

The higher trim comparing unit 115 may determine whether to consider the depreciation rate for vehicle comparison (S61_1). The higher trim comparing unit 115 may inquire of the user terminal 12 whether to consider the depreciation rate or the maintenance cost for vehicle comparison. The user may select an item to be considered for vehicle comparison between the depreciation rate and the maintenance cost for vehicle comparison and input the selected item into the user terminal 12. For example, the higher trim comparing unit 115 may transmit a question inquiring whether to consider the depreciation rate or the maintenance cost to the user terminal 12. When the user terminal 12 receives the question, the application 121 may provide the user through the user terminal 12 with a screen inquiring whether to consider the depreciation rate or maintenance cost for vehicle comparison. When the user inputs a response to the question through the user terminal 12, the application 121 may transmit the response regarding whether to consider the depreciation rate or the maintenance cost to the service providing server 11 through the user terminal 12. When the response received from the user terminal 12 is the response that the depreciation rate is to be considered for vehicle comparison, the higher trim comparing unit 115 may consider the depreciation rate for vehicle comparison.

When the depreciation rate is considered in operation S61_1, the higher trim comparing unit 115 may determine the depreciation rate of each of the reference vehicle and the target vehicle (S62).

When the first difference amount is equal to or greater than 0 in operation S63, the higher trim comparing unit 115 may determine whether the weight of the item representing self-consciousness among the plurality of user propensity factors is equal to or greater than a certain level (S66).

Subsequent operations according to the result of the determination of operation S66 may be the same as operations S67 to S69 described with reference to FIG. 3.

FIG. 7 is a detailed flowchart of operation S6 of FIG. 2 in accordance with some embodiments.

The higher trim comparing unit 115 may determine whether to consider the maintenance cost for vehicle comparison (S61_2). The higher trim comparing unit 115 may inquire of the user terminal 12 whether to consider the depreciation rate or the maintenance cost for vehicle comparison. The user may select an item to be considered for vehicle comparison between the depreciation rate and the maintenance cost for vehicle comparison and input the selected item into the user terminal 12. For example, the higher trim comparing unit 115 may transmit a question inquiring whether to consider the depreciation rate or the maintenance cost to the user terminal 12. When the user terminal 12 receives the question, the application 121 may provide the user through the user terminal 12 with a screen inquiring whether to consider the depreciation rate or the maintenance cost for vehicle comparison. When the user inputs a response to the question through the user terminal 12, the application 121 may transmit the response regarding whether to consider the depreciation rate or the maintenance cost to the service providing server 11 through the user terminal 12. When the response received from the user terminal 12 is the response that the maintenance cost is to be considered for vehicle comparison, the higher trim comparing unit 115 may consider the maintenance cost for vehicle comparison.

When the maintenance cost is considered in operation S61_2, the higher trim comparing unit 115 may determine the maintenance cost of each of the reference vehicle and the target vehicle (S64).

When the second difference amount is equal to or greater than 0 in operation S65, the higher trim comparing unit 115 may determine whether the weight of the item representing self-consciousness among the plurality of user propensity factors is equal to or greater than the predetermined level (S66).

Subsequent operation according to the result of the determination of operation S66 may be the same as operations S67 to S69 described with reference to FIG. 3.

While this invention has been described in connection with what is presently considered to be practical exemplary embodiments, it is to be understood that the invention is not limited to the disclosed embodiments.

What is claimed is:

1. A vehicle comparing method performed by a service providing server, the vehicle comparing method comprising:
providing a user question and a user propensity test to an application through a user terminal;
receiving a response to the user question and the user propensity test from the user terminal;
determining a user propensity based on the response;
calculating a plurality of vehicle compatibilities representing vehicle-specific characteristics for each of the plurality of vehicles;
determining a reference vehicle among the plurality of vehicles by comparing the user propensity with each of the plurality of vehicle compatibilities; and
when receiving a response that at least one of a vehicle depreciation rate and a vehicle maintenance cost is considered from the user terminal, providing vehicle purchase information in which the reference vehicle is compared with a target vehicle corresponding to a higher trim or a higher model of the reference vehicle according to a result of considering at least one of the depreciation rate of the vehicle and the vehicle maintenance cost.

2. The vehicle comparing method of claim 1, wherein:
the determining of the user propensity includes determining the user propensity by a plurality of user propensity factors.

3. The vehicle comparing method of claim 2, wherein the calculating of the plurality of vehicle compatibilities includes:
calculating the vehicle compatibility of each vehicle based on a plurality of vehicle compatibility factors for each of the plurality of vehicles, and
the plurality of vehicle compatibility factors includes factors corresponding to the plurality of user propensity factors.

4. The vehicle comparing method of claim 1, wherein the providing of the vehicle purchase information includes:
determining a depreciation rate of the reference vehicle and a depreciation rate of the target vehicle;
determining whether a first difference amount based on the depreciation rate of the reference vehicle and the depreciation rate of the target vehicle is less than 0; and
when the first difference amount is less than 0, comparing the reference vehicle and the target vehicle and transmitting vehicle comparison information to the user terminal.

5. The vehicle comparing method of claim 4, wherein the determining of the depreciation rate of the reference vehicle and the depreciation rate of the target vehicle includes:
when each of the reference vehicle and the target vehicle is scheduled to be discontinued, determining a depreciation rate of each of the reference vehicle and the target vehicle in consideration of a depreciation rate according to discontinuation;
determining a depreciation amount of each of the reference vehicle and the target vehicle according to the depreciation rate of each of the reference vehicle and the target vehicle; and
determining a value obtained by adding a vehicle price difference between the reference vehicle and the target vehicle, an interest difference according to the vehicle price difference, and a difference in depreciation amount between the reference vehicle and the target vehicle as the first difference amount.

6. The vehicle comparing method of claim 4, wherein the determining of the depreciation rate of the reference vehicle and the depreciation rate of the target vehicle includes:
when each of the reference vehicle and the target vehicle is not scheduled to be discontinued, calculating a depreciation rate according to a vehicle model expected to be sold at a user's used car selling time based on a period from a release of each of the reference vehicle and the target vehicle to a current time point and the user's used car selling time;
reflecting a new model price increase rate of each of the reference vehicle and the target vehicle;
determining a depreciation rate of each of the reference vehicle and the target vehicle in consideration of a depreciation rate according to the model of the vehicle and a new model price increase rate of the vehicle;
determining a depreciation amount of each of the reference vehicle and the target vehicle according to the depreciation rate of each of the reference vehicle and the target vehicle; and
determining a value obtained by adding a vehicle price difference between the reference vehicle and the target vehicle, an interest difference according to the vehicle price difference, and a difference in a depreciation amount between the reference vehicle and the target vehicle as the first difference amount.

7. The vehicle comparing method of claim 4, further comprising:
determining a maintenance cost of the reference vehicle and a maintenance cost of the target vehicle when the first difference amount is 0 or more;
determining whether a second difference amount based on the maintenance cost of the reference vehicle and the maintenance cost of the target vehicle is less than 0; and
when the second difference amount is less than 0, comparing the reference vehicle and the target vehicle and transmitting vehicle comparison information to the user terminal.

8. The vehicle comparing method of claim 7, wherein the determining of the maintenance cost of the reference vehicle and the maintenance cost of the target vehicle includes:
calculating a total maintenance cost of each of the reference vehicle and the target vehicle based on an acquisition tax, an annual fuel cost, and an annual auto tax of each of the reference vehicle and the target vehicle.

9. The vehicle comparing method of claim 8, further comprising:
when it is determined to reflect a used car selling cost of each of the reference vehicle and the target vehicle in a maintenance cost comparison, calculating a total cost for each of the reference vehicle and the target vehicle by adding the depreciation amount at a used car selling time for each of the reference vehicle and the target vehicle and the total maintenance cost of each of the reference vehicle and the target vehicle; and
determining a difference between the total cost for the reference vehicle and the total cost for the target vehicle as a second difference amount.

10. The vehicle comparing method of claim 8, further comprising:
when it is determined not to reflect a used car selling cost of each of the reference vehicle and the target vehicle in a maintenance cost comparison, calculating a total cost for each of the reference vehicle and the target vehicle by adding a vehicle price of each of the reference vehicle and the target vehicle and the total maintenance cost of each of the reference vehicle and the target vehicle; and
determining a difference between the total cost for the reference vehicle and the total cost for the target vehicle as a second difference amount.

11. The vehicle comparing method of claim 7, further comprising:
when the second difference amount is equal to or greater than 0, determining whether a weight of an item representing self-consciousness indicating a user's degree of interest in evaluation of other users on the user is equal to or greater than a predetermined level;
when the weight of the item representing the self-consciousness is equal to or greater than the predetermined level, determining an installment amount of the reference vehicle and an installment amount of the target vehicle; and
comparing the reference vehicle and the target vehicle and transmitting vehicle comparison information to the user terminal.

12. The vehicle comparing method of claim 11, further comprising:
when the weight of the item representing the self-consciousness is less than the predetermined level, transmitting information about the reference vehicle to the user terminal.

13. A vehicle comparison system, the system comprising:
a memory;
a processor electrically connected to the memory, wherein the processor is configured to:
collect user information that is a response to a user question and a response to a user propensity test from a user terminal;
determine the user propensity based on the user information and the response to the user propensity test;
calculate a plurality of vehicle compatibilities representing vehicle-specific characteristics for each of the plurality of vehicles;
determine a reference vehicle among the plurality of vehicles by comparing the user propensity with each of the plurality of vehicle compatibilities; and
when receiving a response that at least one of a vehicle depreciation rate and a vehicle maintenance cost is considered from the user terminal, provide vehicle purchase information in which the reference vehicle is compared with a target vehicle corresponding to a higher trim or a higher model of the reference vehicle according to a result of considering at least one of the depreciation rate of the vehicle and the vehicle maintenance cost.

14. The system of claim 13, wherein:
the user propensity determining unit
performs a clustering operation of setting a plurality of user propensity groups based on a weight distribution for each of a plurality of user propensity factors, and based on the response to the user propensity test for each user, determining a user propensity by matching the weight distribution for each user propensity factor and a similar group among a plurality of user propensity groups.

15. The service providing server of claim 13, wherein the processor is configured to:
calculate the vehicle compatibility of each vehicle based on a plurality of vehicle compatibility factors for each of the plurality of vehicles, and the plurality of vehicle compatibility factors includes factors corresponding to the plurality of user propensity factors.

16. The service providing server of claim 13, wherein the processor is configured to:
determine one of the plurality of vehicles as a reference vehicle by comparing a plurality of user propensity factors indicating the user propensity and a plurality of vehicle compatibility factors indicating a vehicle compatibility for each of the plurality of vehicles.

17. The service providing server of claim 13, wherein the processor is configured to:
determine a depreciation rate of the reference vehicle and a depreciation rate of the target vehicle when the response that at least one of the vehicle depreciation rate and the vehicle maintenance cost is considered is received from the user terminal,
determine a maintenance cost of the reference vehicle and a maintenance cost of the target vehicle when a first difference amount based on the depreciation rate of the reference vehicle and the depreciation rate of the target vehicle is equal to or greater than 0,
determine whether a weight of an item representing self-consciousness indicating the degree of interest of a user in an evaluation of other users on the user is equal to or greater than a predetermined level when a second difference amount based on the maintenance cost of the reference vehicle and the maintenance cost of the target vehicle is equal to or greater than 0, and
determine an installment amount of the reference vehicle and an installment amount of the target vehicle when the weight of the item representing the self-consciousness is equal to or greater than the predetermined level.

18. The service providing server of claim 17, wherein the processor is configured to:
determine a depreciation rate of each of the reference vehicle and the target vehicle in consideration of the depreciation rate according to discontinuation of each of the reference vehicle and the target vehicle when each of the reference vehicle and the target vehicle is scheduled to be discontinued, and
determines a value obtained by adding a vehicle price difference between the reference vehicle and the target vehicle, an interest difference according to the vehicle price difference, and a difference in depreciation rate between the reference vehicle and the target vehicle as the first difference amount.

19. The service providing server of claim 17, wherein the processor is configured to:
when each of the reference vehicle and the target vehicle is not scheduled to be discontinued, determine a depreciation rate of each of the reference vehicle and the target vehicle in consideration of a depreciation rate according to a vehicle model expected to be sold at a user's used car selling time based on a period from a release of each of the reference vehicle and the target vehicle to a current time point and the user's used car selling time and a new model price increase rate of the vehicle, and
determine a value obtained by adding a vehicle price difference between the reference vehicle and the target vehicle, an interest difference according to the vehicle price difference, and a difference in a depreciation rate between the reference vehicle and the target vehicle as the first difference amount.

20. The service providing server of claim 17, wherein the processor is configured to:
calculate a total maintenance cost of each of the reference vehicle and the target vehicle based on an acquisition tax, an annual fuel cost, and an annual auto tax of each of the reference vehicle and the target vehicle, and
calculates a total cost for each of the reference vehicle and the target vehicle by adding the depreciation amount at a used car selling time for each of the reference vehicle and the target vehicle and the total maintenance cost of each of the reference vehicle and the target vehicle when receiving a response that a used car selling cost of the vehicle is reflected from the user terminal, and determines a difference in the total cost between the reference vehicle and the target vehicle as the second difference amount.

21. The service providing server of claim 17, wherein the processor is configured to:
calculate the total maintenance cost of each of the reference vehicle and the target vehicle based on an acquisition tax, an annual fuel cost, and an annual auto tax of each of the reference vehicle and the target vehicle, and
calculates a total cost for each of the reference vehicle and the target vehicle by adding a vehicle price for each of the reference vehicle and the target vehicle and the total maintenance cost of each of the reference vehicle and the target vehicle when receiving a response that a used car selling cost of the vehicle is not reflected from the user terminal, and determines a difference in the total cost between the reference vehicle and the target vehicle as the second difference amount.

22. The service providing server of claim 17, wherein the processor is configured to:
when the first difference amount is less than 0, the second difference amount is less than 0, or the weight of the item representing the self-consciousness is equal to or greater than the predetermined level, transmit comparison information between the reference vehicle and the target vehicle to the user terminal.

23. The service providing server of claim 22, wherein the processor is configured to:
when the weight of the item representing the self-consciousness is less than the predetermined level, transmit information about the reference vehicle to the user terminal.
